(19) United States
(12) Patent Application Publication
(10) Pub. No.: US 2024/0166368 A1
(43) Pub. Date: May 23, 2024

(54) Hose Retainer

(71) Applicant: Government of the United States, as represented by the Secretary of the Air Force, Wright-Patterson AFB, OH (US)

(72) Inventors: Alexander Gambill, O'Fallon, MO (US); Nathan Hodges, Edmond, OK (US); Christian Schafer, Edmond, OK (US)

(21) Appl. No.: 18/380,238

(22) Filed: Oct. 16, 2023

Related U.S. Application Data
(60) Provisional application No. 63/427,121, filed on Nov. 22, 2022.

(51) Int. Cl. B64F 1/28

(52) U.S. Cl. CPC B64F 1/28

(57) ABSTRACT

A hose holder for holding a hose inside an opening in a structure is disclosed. The hose holder includes a hose engagement portion configured to surround at least a portion of a hose and perimeter engaging portions joined to the hose engagement portion for engaging the portions of the structure adjacent to the opening into which the hose is inserted and holding a hose within the opening.

Pursuant to 37 C.F.R. § 1.78(a)(4), this application claims the benefit of and priority to prior filed co-pending Provisional Application Ser. No. 63/427,121 filed Nov. 22, 2022, which is expressly incorporated herein by reference.

### RIGHTS OF THE GOVERNMENT

The invention described herein may be manufactured and used by or for the Government of the United States for all governmental purposes without the payment of any royalty.

### FIELD OF THE INVENTION

The present invention relates generally to devices for holding hoses in place within an opening and, more particularly, to a removable bracket for holding a collared hose inside an opening in a structure.

### BACKGROUND OF THE INVENTION

Certain maintenance tasks require work to be performed in confined spaces. The maintenance of aircraft, for example, requires tasks to be periodically performed in confined spaces. For instance, it is necessary for fuel to be removed from aircraft fuel tanks and for mechanics to perform work inside aircraft fuel tanks. A supply of breathing air must be provided to such confined spaces. The breathing air is supplied with a hose that is inserted into an access opening on the underside of an aircraft fuel tank.

There does not currently appear to be a satisfactory way to hold hoses within such an opening. There are hose clamps in existence for different systems, but there does not appear to be a retaining system for fresh air supplied by Ground Support Equipment (GSE) collared hoses for aircraft. If the GSE collared hose is not securely attached to the access opening, the GSE collared hose can become dislodged from the fuel tank opening and become a hazard to those below. A different style of hose is sometimes duct taped to the access opening of a fuel tank, but the other hose style is very easily damaged or can fall out of the opening easily as well.

Therefore, a need exists for an improved device for holding hoses in place within openings, particularly for holding collared hoses in place in an opening in the underside of a structure.

### SUMMARY OF THE INVENTION

The present invention relates generally to devices for holding hoses in place within an opening and, more particularly, to a removable bracket for holding a collared hose inside an opening in a structure.

While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a hose holder for holding a hose inside an opening in a structure is disclosed. The hose holder has a top surface and a bottom surface. The hose holder comprises:
a hose engagement portion configured to surround at least a portion of a hose;
and

perimeter engaging portions joined to the hose engagement portion for engaging the portions of the structure adjacent to the opening into which the hose is inserted and holding the hose holder within the opening.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view showing a portion of an access opening of an aircraft fuel tank with one embodiment of the hose holder holding a fresh air hose in place therein.

FIG. 2 is a top perspective view of one embodiment of the hose holder.

FIG. 3 is a top view of the hose holder.

FIG. 4 is a bottom perspective view of the hose holder.

FIG. 5 is a bottom view of the hose holder.

FIG. 6 is a side view of the hose holder from one side.

FIG. 7 is an end view of the hose holder from the first end.

FIG. 8 is an end view of the hose holder from the second end.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity of illustration.

### DETAILED DESCRIPTION OF THE INVENTION

The present invention relates generally to devices for holding hoses in place within an opening and, more particularly, to a removable bracket for holding a collared hose inside an opening in a structure.

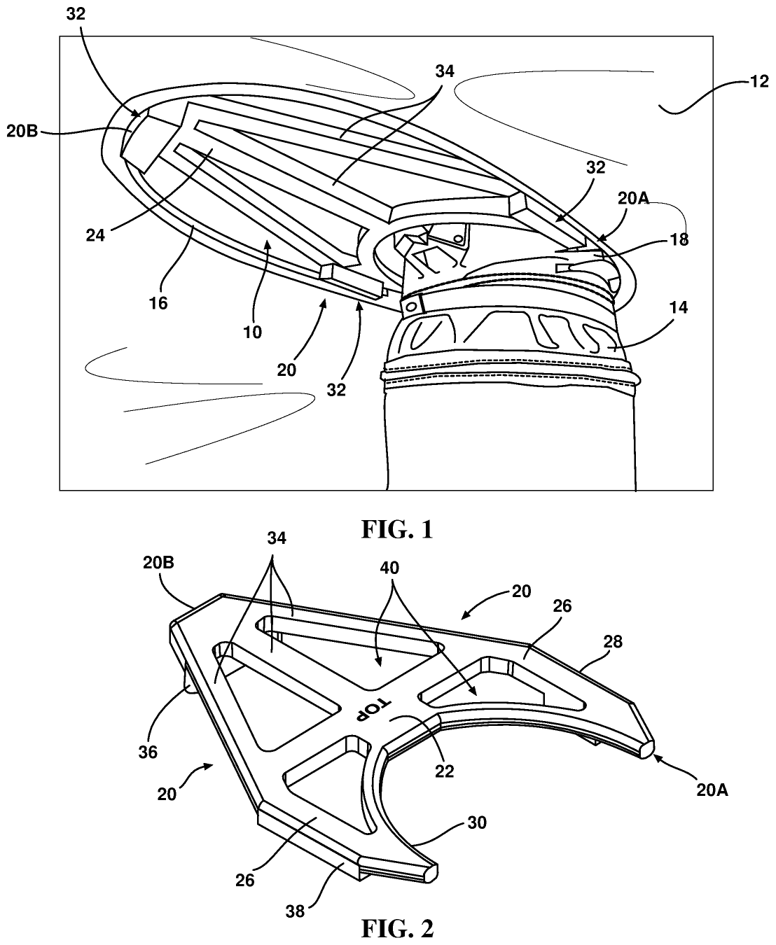

FIG. 1 shows a portion of an opening in a structure such as an access opening 10 of an aircraft fuel tank 12. FIG. 1 shows one embodiment of a hose holder (or “hose retainer”) 20 for holding a fresh air hose 14 in place therein. The hose holder 20 is in the form of a removable bracket. The access opening 10 is only used for maintenance personnel to climb inside the fuel tank. Fuel is not inserted through the access opening. Portions of the fuel tank are adjacent to and form a rim 16 around the access opening 10. The portions along the rim 16 of the opening 10 can be considered to lie within a common plane. It should be understood that while the drawings show the hose holder being used for inserting a hose into the access opening of an aircraft fuel tank, the hose holder 20 can be used for holding a hose in the opening of any type of structure. The hose holder 20 is particularly useful for holding a hose in an opening on the underside of a structure.

The hose holder 20 can be used to hold any suitable type of hose in an opening on the underside of a structure. The hose holder 20 is particularly useful for holding Ground Support Equipment (GSE) collared hoses used to supply aircraft with fresh air. As shown in FIG. 1, the hose holder 20 may be used to hold one end of the hose by its collar 18.

FIGS. 1 and 2 show that the hose holder 20 has a first end 20A, a second end 20B, a top surface 22, a bottom surface 24, a plurality of sides 26, and a perimeter 28. The perimeter 28 has dimensions, at least some of which are larger than the dimensions of the opening 10. The hose holder 20 may comprise a hose engagement portion 30, perimeter engaging portions 32, structural members 34, opening positioners 36 (shown in FIG. 4), and supporting pads 38. When the hose holder 20 is used for inserting a hose into the access opening of an aircraft fuel tank, the hose holder 20 may have one or more holes 40 therein to let air flow out of the access opening. The hose holder 20 can be provided in various sizes designed to match the dimensions of a specific hose, hose collar, and opening.

The hose engagement portion 30, in the embodiment shown, is located at the first end 20A of the hose holder 20. The hose engagement portion 30 is configured to surround at least a portion of the sides of a hose at one end of the hose 14. The hose engagement portion 30 may be designed to match the diameter and curvature of the hose entering the opening 10, but may be slightly larger than both the diameter and curvature of the hose. In the embodiment shown, the hose engagement portion 30 has a generally semi-circular configuration that is open on one side. This configuration enables the hose holder 20 to use the hose engagement portion 30 to hold a portion of the side of the hose 14 while the opposing side of the hose 14 is held against a portion of the rim 16 around the access opening 10. Other configurations the hose engagement portion 30 are possible. For instance, in some embodiments the hose engagement portion 30 may be circular so that it completely surrounds the sides of the hose 14. The hose engagement portion 30 may, therefore, form any suitable portion of a complete circle. In addition, all or portions, of the hose engagement portion 30 may be formed by rectilinear segments instead of, or in addition to curvilinear segments.

The perimeter engaging portions 32 (shown in FIGS. 1 and 4) are joined (at least indirectly) to the hose engagement portion 30. The term “joined”, as used herein, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined” includes both those configurations in which an element is temporarily joined to another element, or in which an element is permanently joined to another element.

The perimeter engaging portions 32 engage the portions of the structure adjacent to the opening 10 (e.g., the rim 16 around the access opening 10) into which the hose 14 is inserted to hold a hose within the opening. The perimeter engaging portions 32 comprise the portions of the hose holder 20 that directly contact the rim 16 around the access opening 10, as well as parts of the hose holder that are adjacent to such portions. The perimeter engaging portions 32 may comprise portions of the structural members 34. The perimeter engaging portions 32 may also comprise the opening positioners 36 and the supporting pads 38 since those components may be in direct contact with portions of the structure adjacent to the opening 10. There may be any suitable number of perimeter engaging portions 32.

In the embodiment shown in the drawings, there are three perimeter engaging portions 32. As shown in FIG. 4, these comprise a first perimeter engaging portion 32A, a second perimeter engaging portion 32B, and a third perimeter engaging portion 32C. The first perimeter engaging portion 32A is on one side of the hose holder 20 adjacent to the hose engagement portion 30. The second perimeter engaging portion 32B is on the opposite side of the hose holder 20 adjacent to the hose engagement portion 30. The third perimeter engaging portion 32C is located on the second end 20B of the hose holder 20.

The structural members 34 form connections between the perimeter engaging portions 32 of the hose holder 20 and other parts of the hose holder to form a unitary structure. Thus, at least some of the structural members 34 may be considered to connect (or join) the perimeter engaging portions 32 to each other. The top and bottom surfaces of the structural members 34 will be considered to form the top surface 22 and bottom surface 24, respectively, of the body of the hose holder 20. There can be any suitable number of structural members 34, and they may have any suitable configurations.

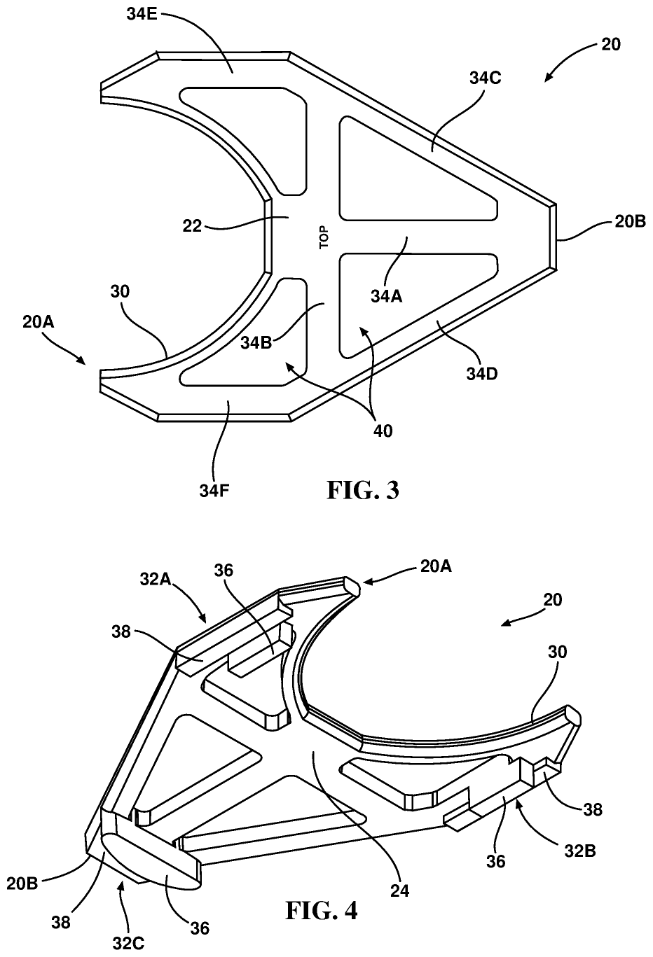

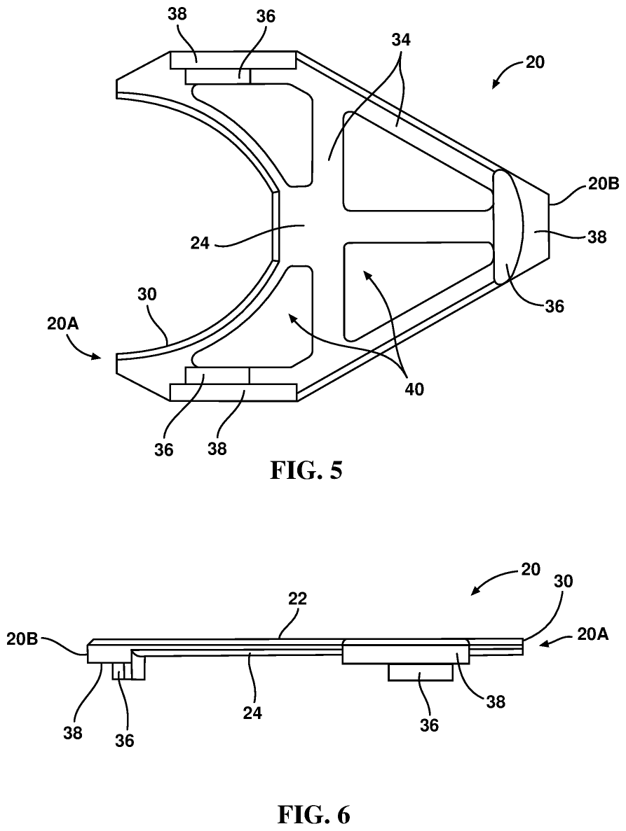

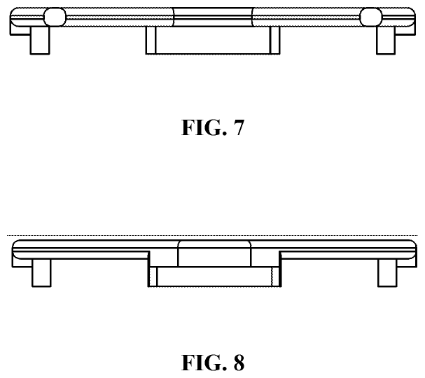

In the embodiment shown, the hose holder 20 comprises six structural members 34. As shown in FIG. 3, these comprise a first structural member 34A, a second structural member 34B, a third structural member 34C, a fourth structural member 34D, a fifth structural member 34E, and a sixth structural member 34F. The first structural member (or longitudinal structural member) 34A extends between the hose engagement portion 30 and the second end 20B of the hose holder. The second structural member (or transverse structural member) 34B extends between the sides 26 of the hose holder 20. The second structural member 34B may form a right angle with the first structural member 34A. The third structural member 34C extends along the first side of the hose holder 20 between the second end 20B of the hose holder and the first perimeter engaging portion 32A. The fourth structural member 34D extends along the second side of the hose holder 20 between the second end 20B of the hose holder and the second perimeter engaging portion 32B. The third and fourth structural members 34C and 34D may form an angle of less than or equal to about 45° with the first structural member 34A. The fifth structural member 34E is generally parallel to the first structural member 34A. The fifth structural member 34E extends from one end of the third structural member 34C to the first end 20A of the hose holder 20 where it is joined to the hose engagement portion 30. The sixth structural member 34F is also generally parallel to the first structural member 34A. The sixth structural member 34F extends from one end of the fourth structural member 34D to the first end 20A of the hose holder 20 where it is also joined to the hose engagement portion 30. The structural members 34 may have holes 40 therebetween to allow air to leave the confined space through the holes 40 in between the structural members 34.

The opening positioners (or “positioners”) 36 are joined to the bottom surface 24 of the hose holder 20 and extend generally normal to the bottom surface 24. In use, the opening positioners 36 will touch the rim 16 around the access opening 10 and extend through the opening 10. They keep the hose holder 20 and the air hose 14 from moving laterally as well as forwards and backwards in the opening 10. There can be any suitable number of opening positioners 36. The positioners 36 can have any suitable configuration. In the embodiment shown in the drawings, there are three opening positioners, one at each of the perimeter engaging portions 32. As shown in the drawings, one or more of the positioners 36 can have convex curvilinear outer surface similar to the curvature of the opening which the hose holder is designed to fit.

The supporting pads 38 support the weight of the hose 14 and the hose holder 20 and rest on the rim 16 around the access opening 10 (e.g., the interior skin of the fuel tank). There may be a plurality of supporting pads 38 joined to the bottom surface of the hose holder 20. The supporting pads 38 are located adjacent to the opening positioners 36. The supporting pads 38 are positioned laterally or longitudinally outward of the opening positioners 36 along portions of the perimeter 28 of the hose holder. There may be any suitable number of supporting pads 38, and they may have any suitable configuration. In the embodiment shown, there are three supporting pads 38 and two of them have rectangular configurations. The supporting pads 38 may be made of the same material as the other portions of the hose holder 20, or they may be made of a softer material.

The hose holder 20 can further comprise a locking latch mechanism to better secure the hose inside the confined space opening. However, the need for this added security must be weighed against the safety of individuals inside the confined space and the potential for emergency egress as this functionality will marginally slow the confined space exit process.

The hose holder 20 should have sufficient rigidity to hold the hose 14 in the opening 10. The hose holder 20 may be rigid so that it does not bend under the conditions of installation and/or use. Alternatively, one or more portions of the hose holder 20 may have a degree of flexibility so that such portions may flex to a degree when installing the hose holder in the opening and/or during use and/or removal of the hose holder 20. If the hose holder 20 is flexible, it may be desirable for the hose holder to be resiliently flexible so that it returns to its original configuration after it is bent or flexed.

The hose holder 20 can be made from any suitable materials by any suitable process. The hose holder 20, or portions thereof, can be made of wood, metal, or polymeric material. One material that is particularly suitable for the hose holder 20 is polycarbonate. The hose holder 20 can be 3D printed or cast in a variety of materials. It may be desirable for the material that is used to make the hose holder 20 meet or exceed the material properties of polycarbonate. If the hose holder 20 is 3D printed, it can be printed on a STRATASYS® FORTUS 450mc™ 3D printer available from Stratasys, Inc., Eden Prairie, MN, or on other 3D printers capable of meeting or exceeding the build tolerance and build volume of the STRATASYS® FORTUS 450mc™ 3D printer.

The hose holder 20 can be installed and removed from inside or outside the opening 10 in the structure. The hose holder 20 can, therefore, be installed by a single person who climbs inside the opening in the structure with the hose holder 20 and pulls one end of the hose into the opening 10. For installation, the hose holder 20 is turned sideways so that one of the sides or ends of the hose holder is first inserted into the opening 10. The hose holder 20 is then completely inserted through the opening 10. The collared portion of the hose 14 is also inserted through the opening 10. After the hose 14 and the hose holder 20 are both inside the structure (e.g., the fuel tank) but before the hose holder 20 is rested on the rim of the opening, the hose holder 20 can then be placed on the hose. The hose engagement portion 30 of the hose holder 20 is placed around at least a portion of the GSE collared air hose. The hose holder 20 is then adjusted relative to the opening 10 so that it rests supporting the hose collar against the outer edges 16 of the opening 10. The hose 14 and hose holder 20 can be removed by reversing the installation steps. In the event of an emergency confined space evacuation, the tool and air hose can be removed by tilting the second end 20B upwards. This will allow the GSE collared air hose to fall out of the opening.

A method of holding an end of a hose inside an opening in the underside of a structure wherein the opening is larger than the end of the hose is also provided herein. The method may comprise:
a) providing a hose holder as described above;
b) turning or tilting the hose holder on one of its sides or ends, and inserting the hose holder through the opening on the underside of the structure;
c) inserting the end of a hose into the opening on the underside of the structure;
d) turning the hose holder so that its bottom surface faces the portions of the structure adjacent to the opening on the underside of the structure and inserting the end of the hose into the hose engagement portion; and
e) aligning the perimeter engaging portions of the hose holder with the portions of the structure adjacent to the opening on the underside of the structure, and allowing the perimeter engaging portions to rest on the portions of the structure adjacent to the opening on the underside of the structure.

The steps of the method can be performed in any suitable order. In addition, as used herein, an element or step recited in the singular and preceded with the word “a” or “an” should be understood as including the plural of such elements or steps, unless the plural of such elements or steps is specifically excluded.

In the configuration shown in the drawings, the hose holder 20 is designed for a specific collared air hose and the confined space fuel tank openings of the Boeing 707 air frame. However, there are numerous, non-limiting embodiments of the hose holder 20 and configurations thereof. Other variations may have a similar configuration with dimensional modifications for different hoses or different openings.

The hose holder 20 can be used in any circumstance where collared hoses are required in confined spaces including aircraft maintenance/construction, automotive maintenance/construction, aquatic maintenance/construction, general construction and deconstruction use, sewage and plumbing work, and mining.

The hose holder 20 can provide a number of advantages. It should be understood, however, that these advantages need not be required unless they are set forth in the appended claims. The hose holder provides a more secure way to hold a hose in an opening in the underside of a structure. The hose holder greatly improves the safety of those working around a structure with an opening on the underside thereof by not allowing the hose to become dislodged. This also improves process efficiency inside aircraft fuel tanks as there is no need to re-insert a GSE collared hose each time it becomes dislodged.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A hose holder for holding a hose inside an opening in a structure, said hose holder having a top surface and a bottom surface, said hose holder comprising:
a hose engagement portion configured to surround at least a portion of a hose; and
perimeter engaging portions joined to said hose engagement portion for engaging the portions of the structure adjacent to the opening into which the hose is inserted and holding the hose holder within the opening.

2. The hose holder of claim 1 further comprising a plurality of structural members that form connections between the perimeter engaging portions of the hose holder and other parts of the hose holder to form a unitary structure, wherein the structural members define openings therebetween to let air flow through said openings.

3. The hose holder of claim 1 wherein said hose holder further comprises a plurality of opening positioners that extend generally normal to the bottom surface of the hose holder.

4. The hose holder of claim 1 further comprising a plurality of supporting pads joined to the bottom surface of said hose holder.

5. A method of holding an end of a hose inside an opening in the underside of a structure wherein the opening is larger than the end of the hose, said method comprising:
a) providing a hose holder having a top surface, a bottom surface, a plurality of sides, a pair of ends, and a perimeter having dimensions, wherein at least some of said dimensions of said perimeter are larger than the opening in the underside of a structure, said hose holder comprising:
a hose engagement portion configured to surround at least a portion of a hose; and
perimeter engaging portions joined to said hose engagement portion for engaging the portions of the structure adjacent to the opening into which the hose is inserted and holding a hose within the opening;
b) turning the hose holder on one of its sides or ends, and inserting the hose holder through the opening on the underside of the structure;
c) inserting the end of a hose into the opening on the underside of the structure;
d) turning the hose holder so that its bottom surface faces the portions of the structure adjacent to the opening on the underside of the structure and inserting the end of the hose into the hose engagement portion; and
e) aligning the perimeter engaging portions of the hose holder with the portions of the structure adjacent to the opening on the underside of the structure, and allowing the perimeter engaging portions to rest on the portions of the structure adjacent to the opening on the underside of the structure.

6. The method of claim 5 wherein the hose holder further comprises a plurality of opening positioners that extend generally normal to the bottom surface and are spaced inward of the opening on the underside of the structure, and during the step of aligning the perimeter engaging portions of the hose holder with the portions of the structure adjacent to the opening on the underside of the structure, the opening positioners are positioned inside the opening and restrict the hose holder from shifting laterally in the opening.

7. The method of claim 6 wherein the structure is an aircraft fuel tank and the opening is an access opening for maintenance personnel to enter the fuel tank, wherein the method further comprises:
prior to the step of turning the hose holder on one of its sides or ends, and inserting the hose holder through the opening on the underside of the structure, having a person climb into the structure through the opening on the underside of the structure, wherein the person pulls one end of the hose into the opening on the underside of the structure.
